(19) United States
(12) Patent Application Publication
(10) Pub. No.: US 2022/0108017 A1
(43) Pub. Date: Apr. 7, 2022

(54) FIRMWARE TO RESTORE CONFIGURABLE OPTION

(71) Applicant: Hewlett-Packard Development Company, L.P., Spring, TX (US)

(72) Inventors: Chin-Yu Wang, Taipei City (TW); Christoph Graham, Spring, TX (US)

(73) Assignee: Hewlett-Packard Development Company, L.P., Spring, TX (US)

(21) Appl. No.: 17/419,215

(22) PCT Filed: Jun. 24, 2019
(86) PCT No.: PCT/US2019/038700

§ 371 Date: Jun. 28, 2021

(51) Int. Cl. G06F 21/57; G06F 21/60; G06F 21/79; G06F 9/445

(52) U.S. Cl. CPC G06F 21/572; G06F 9/44505; G06F 21/79; G06F 21/602

(57) ABSTRACT

In an example implementation according to aspects of the present disclosure, a system comprises a firmware controller and non-volatile memory. The firmware controller retrieves a set of configurable system options from a configuration segment of the non-volatile memory. The firmware controller stores the set of configurable system options in a reserved storage location. The firmware controller updates a set of firmware instructions from a system segment of the non-volatile memory. The firmware controller retrieves the set of configurable system options from the reserved storage location. The firmware controller restores the set of configurable system options utilizing an application programming interface provided by the firmware instructions.

### BACKGROUND

Firmware provides low level software support for a central processing unit (CPU) or a family of CPUs. The firmware implements functionality corresponding to the CPU and a set of system features installed in a computer system. Firmware may be upgraded to correct bugs, patch security holes, and add features.

### BRIEF DESCRIPTION OF THE DRAWINGS

FIG. 1 is a block diagram illustrating system for firmware to restore configurable options, according to an example;

FIG. 2A and FIG. 2B are diagrams illustrating non-volatile memory in various states during a firmware saving and restoring configurable options, according to another example of the present disclosure;

FIG. 3 is a flow diagram illustrating a method for firmware to restore configurable options, according to an example; and

FIG. 4 is a computing device for supporting a firmware to restore configurable options, according to an example.

### DETAILED DESCRIPTION

As part of a computer system, platform firmware packages, also called BIOS packages, provide support for low level device interfaces. The firmware provides support for particular central processing units (CPUs) that are compatible for the computer system. The CPU support within the firmware allows a user to physically upgrade the CPU to a different CPU and the computer system will boot properly. Additionally, firmware provides support for the underlying system architecture and circuity to support the CPU. The underlying system architecture may include configurable system options to tailor performance for different users. Configurable system options correspond to a set of controlling variables for the installed set of firmware instructions. Some configurable system options may correspond to user visible configurable variables utilized by a user to affect the performance of the computer system. Other configurable system options may correspond to system variables that are not user visible that support the underlying system platform and architecture.

During a computer system platform's lifespan, updating the firmware may be necessary to update the code that supports the CPU and the underlying system architecture. Firmware may be updated to correct firmware bugs, secure potential security threats, and enable new features. Software tools may write new firmware image files to the non-volatile memory hosting the firmware. During the writing process, changes in the image sizes and variables within the firmware image may overwrite address segments corresponding to different functional portions of the firmware to support various functional blocks. For example, a user visible configurable variable may be overwritten by a system configurable variable (non-user visible) in order to support a new feature. In this example, the user visible configurable variable may be lost. Described herein is a system to preserve system configuration options when the firmware variable segments change during firmware updates.

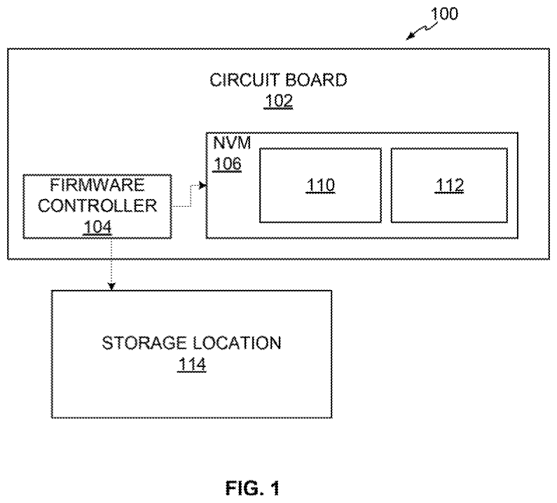

FIG. 1 is a block diagram illustrating system 100 for firmware to restore configurable options, according to an example. The system 100 may include a circuit board 102, a firmware controller 104 and a non-volatile memory 106.

In one example of the system 100, the firmware controller 104 may be configured to retrieve a set of configurable system options from a configuration segment 110 of the non-volatile memory 106. The firmware controller 104 may store the set of configurable system options in a reserved storage location 114. The firmware controller 104 may update a set of firmware instructions from a system segment 112 of the non-volatile memory 106. The firmware 104 may retrieve the set of configurable system options from the reserved storage location 114. The firmware controller 104 may restore the set of configurable system options utilizing an application programming interface (API) provided by the firmware instructions.

The circuit board 102 may include a host board such as a motherboard or mainboard. The circuit board 102 may be included in a larger system such as a mobile phone, tablet, laptop or desktop computing device. In other implementations, the circuit board 102 may be included in retail computing systems such as kiosk, retail point of sale devices or display boards. The circuit board 102 may include support circuitry to provide data transfer between the firmware controller 104 and the non-volatile memory 110. The circuit board 102 may also provide a power supply to the firmware controller 104 and the non-volatile memory 106. The circuit board 102 may provide electrical and data communicative support for additional storage devices including storage location 114.

The firmware controller 104 provides low level support logical support for the system 100. The system 100 may include a central processing unit (CPU, not shown) as well as supporting infrastructure to support the CPU. The firmware controller 104 may include logic for loading instructions from the non-volatile memory 106 when the system 100 is boot strapping. The firmware controller 104 may load execute the instructions to initialize any supporting system architecture in order to hand off control of the system to the CPU and the operating system.

The non-volatile memory 106 may be electrically coupled to the firmware controller 104. The non-volatile memory 106 may contain machine code instructions specific to the hardware configuration of the system 100, including the CPU, chipset and peripherals. The non-volatile memory 106 may include a set of configurable system options pertinent to operating the system 100 in accordance to a user's indication. The set of configurable system options may include variable corresponding to system device enablement, time and date, and system boot sequence. The set of configurable system options may be visible in a unified extensible firmware interface (UEFI) graphical user interface (GUI) for modification by a user. The UEFI GUI may be manipulated at system boot, prior to the firmware controller 104 handing control over to the operating system. Additionally, a set of non-configurable system options may be stored in the non-volatile memory 106. The non-configurable system options may be variables utilized for the system 100 for stability or other internal functions. User modification of the non-configurable system options may cause system instability, and thereby may render the system unusable if misconfigured. The set of non-configurable system options may be hidden from the user or may be presented in the UEFI GUI as non-editable.

The set of configurable and non-configurable system options may reside in a configuration segment 110 of the non-volatile memory 106. The address location of both sets may change during the lifetime of the system as system updates are applied. The configuration segment 110 may be organized into blocks of memory pertaining to each system option. The firmware controller 104 may access the configuration segment 110 to retrieve values corresponding to the variables for system start up.

A system segment 112 within the non-volatile memory 106 may include firmware instructions for the initialization of the system 100. The system segment 112 may also include the set or a subset of non-configurable system options, whereby the set of configurable system options reside in the configuration segment 110. The system segment may include of set of firmware instructions corresponding to drivers for chipset operation. The system segment 112 may change in size and address location through the lifetime of the system as firmware updates are applied for various reasons including but not limited to bug fixes, security patches, design flaw work arounds, and new features. The system segment 112 may include machine code instructions for initializing devices (e.g. drivers).

A storage location 114 may be communicatively connected to the firmware controller 104. The storage location 114 may be a non-volatile memory location apart from the non-volatile memory 106. The storage location 114 may be a temporary storage location that characteristically may retain memory settings after power supply is lost. For example, hard disk storage or solid-state storage may be utilized for the storage location 114. In another implementation, the storage location 114 may be utilized in the non-volatile memory 106. The non-volatile memory 106 may have addressable memory blocks exceeding the requirements for the configuration segment 110 and the system segment 112. The excess blocks may be utilized as a temporary storage medium for the storage location 114. The reserved secure memory location

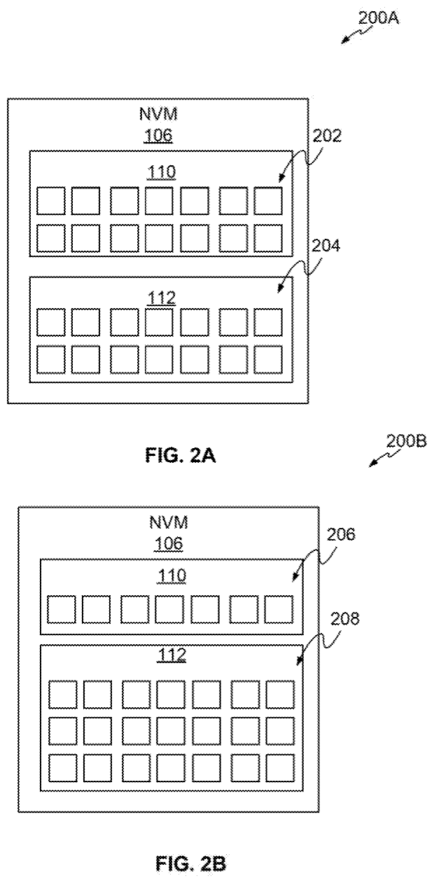

FIG. 2A is a diagram 200A illustrating non-volatile memory in firmware saving state, according to another example of the present disclosure. Referring to FIG. 1, FIG. 2A and FIG. 2B further illustrates the non-volatile memory 106, the configuration segment 110 and the system segment 112.

Within the configuration segment 110 of the non-volatile memory 106, may exists a set of configuration segment memory blocks 202. The set of configuration segment memory blocks 202 may correspond to configuration variables or attributes that may be configurable or non-configurable. The allocation of the configuration segment memory blocks 202 correspond to functionality built into the system segment 112 of the non-volatile memory. The system segment 112 of the non-volatile memory contains a number of application programming interface (API) methods. The methods may pertain to “get” and “set” methods (or accessors) for each of the configuration variables. It should be noted that the set methods may be only internally accessible by the firmware controller 104 and not accessible through a UEFI GUI for non-configurable variables.

In a saving state, the firmware controller 104 may execute all of the “get” methods included in the system segment 112. Each “get” method call retrieves a value from the set of configuration segment memory blocks. Over the course of the saving state, the firmware controller 104 may execute every “get” method and retrieve every variable in the set of configuration segment memory blocks.

Referring back to FIG.1, the firmware controller 104 may store the resultant values from the execution of every “get” method, into the storage location 114. The firmware controller 104 may store the values in a method suitable to the physical medium supporting the storage location 114. In one implementation, the firmware controller 114 may encrypt the resultant values prior to writing them in the storage location 114. As the storage location 114, may not be in a secure location, encryption allows for the firmware controller 104 to maintain not only the resultant value security from tampering, but also may also detect corruption.

In a saving state, system segment 112 may remain unchanged. In one implementation, the set of non-configurable system options may reside in the system segment 112. The system segment 112 may include system segment memory blocks 204. The system segment memory blocks 204 are individually addressable areas that include machine code to support the system executed by the firmware controller 104. Additionally, the set of non-configurable system options may reside in the system segment 112 or the configuration segment 110, as previously discussed.

FIG. 2B is a diagram 200B illustrating non-volatile memory in firmware restoring state, according to another example of the present disclosure.

In the restoring state, the set of configurable and non-configurable system options may change in number and location. In this implementation, the configuration segment 110, has had the configuration segment memory blocks 206 reduced by half. Additionally, the system segment memory blocks 208 have increased by half. A portion of the save state configuration segment memory blocks 202 (see FIG. 2A) have been allocated to the system segment memory blocks 208. The contents of the reallocated memory blocks have been lost, however upon restoration, the firmware controller 104, as will be described later, adjusts the addresses of the values and writes them to the appropriate memory segments so that the system is stable.

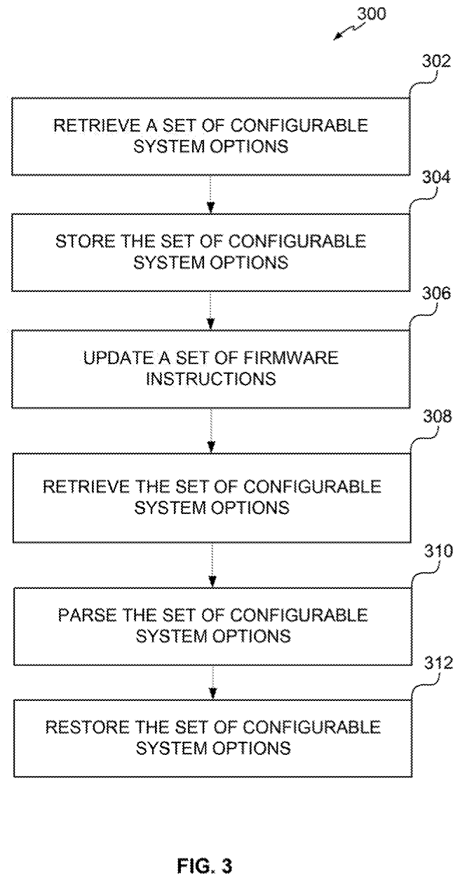

FIG. 3 is a flow diagram 300 illustrating a method for firmware to restore configurable options, according to an example. In describing the method here within, reference to previously discussed figures may be used for clarity.

At 302, the firmware controller 104, retrieves a set of configurable system options. The firmware controller 104 may utilize an API to request and receive a set of configurable system options. The firmware controller 104 may query the firmware image stored in non-volatile memory for the accessor functions present within the firmware to request each of the set of configurable system options. The firmware controller 104 may iterate over all of the accessor functions to request and receive the set of configurable system options from the non-volatile memory.

At 304, the firmware controller 104 stores the set of configurable system options. The firmware controller 104 may access a storage location and write the set of configurable system options. In one implementation, the firmware controller 104 may encrypt the set of configurable system options prior to storing the set of configurable system options. As described above, the storage location may include a hard disc drive, a solid-state drive, unallocated/reserved areas of non-volatile memory, and any other attached storage device. The storing of the set of configurable system options may include writing the set of configurable system options to a flat file. Each of the set of configurable system options may be stored in a format that the firmware controller 104 can read and write. For example, the firmware controller 104 may be configured to write each of the set of configurable system options as keyword value pairs. In another implementation, the firmware controller 104 may store the set of configurable system options in an extensible markup language (XML) tree utilizing an XML library. The firmware controller 104 may utilize the library for parsing the tree and writing the XML encoded set of configuration options to the storage location

At 306, the firmware controller 104, updates a set of firmware instructions. The firmware controller may write a new set of firmware instructions from a firmware image file to a system segment of non-volatile memory. The firmware image file may include new functionality, security patches, and bug fixes, encoded in machine code. The firmware image may be a different size written to non-volatile memory than the previously installed (and executing) firmware image. The difference in size may overwrite memory addresses in a different segment of non-volatile memory, wherein the different segment previously contained a subset of the configurable system options. In some implementations, the updating the set of firmware instructions may be called “flashing” the firmware. Flashing may include the writing and verifying of a firmware image to the non-volatile memory 106 on the circuit board 102. In some implementations, the updating may include overwriting both the system segment and a portion of the configuration segment.

At 308, the firmware controller 104, retrieves the set of configurable system options. Upon completion of the “flashing” of the firmware, the firmware controller 104 retrieves the set of configurable system options from the storage location. The firmware controller 104 may utilize a built-in read function similar to the write/store function previously executed. A decryption algorithm may be utilized as a complement to the encryption that may have been performed earlier. The decryption allows the firmware controller 104 to operate on the set of configurable system options in clear text.

At 310, the firmware controller 104 parses the set of configurable system options. The firmware controller 104 may utilize a parsing algorithm similar to the writing method previously mentioned to receive the set of configuration values in clear text. The firmware controller 104 may parse the stored set of configurable system options using an applicable parser. For example, if the stored set of configurable system options were stored using XML, and XML parser would be utilized to ingest the set of configurable system options from the XML tree.

At 312, the firmware controller 104 restores the set of configurable system options. Once parsed, the firmware controller 104 may utilize the firmware API to request the accessor “set” functions for the newly installed firmware image. The firmware controller 104 may align the writing of the set of configuration system options to correspond to the configuration segment memory blocks 206 available after the flashing. As the firmware image may include new functionality, the API may be updated to include new configuration system options and therefore contain the associated accessor functions to write any new values as well as restoring any retrieved values using the “set” accessor.

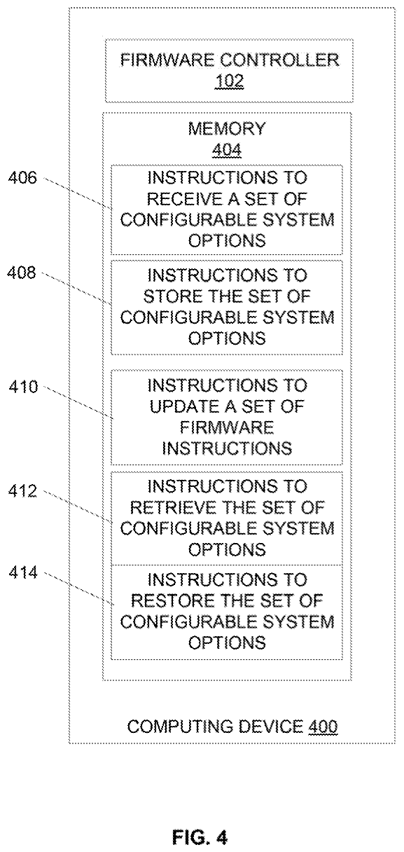

FIG. 4 is a computing device for supporting a firmware to restore configurable options. The computing device 400 depicts a firmware controller 104 and a memory 404 and, as an example of the computing device 400 performing its operations, the memory 404 may include instructions 406-414 that are executable by the firmware controller 104. The firmware controller 104 may be synonymous with the processor found in common computing environments including but not limited to central processing units (CPUs). The memory 404 can be said to store program instructions that, when executed by firmware controller 104, implement the components of the computing device 400. The executable program instructions stored in the memory 404 include, as an example, instructions to receive a set of configurable system options 406, instruction to store the set of configurable system options 408, instructions to update a set of firmware instructions 410, instructions to retrieve the set of configurable system options 412, and instructions to restore the set of configurable system options 414.

Memory 404 represents generally any number of memory components capable of storing instructions that can be executed by firmware controller 104. Memory 404 is non-transitory in the sense that it does not encompass a transitory signal but instead is made up of at least one memory component configured to store the relevant instructions. As a result, the memory 404 may be a non-transitory computer-readable storage medium. Memory 404 may be implemented in a single device or distributed across devices. Likewise, firmware controller 104 represents any number of processors capable of executing instructions stored by memory device 404. The firmware controller 104 may be integrated in a single device or distributed across devices. Further, memory 404 may be fully or partially integrated in the same device as firmware controller 104, or it may be separate but accessible to that device and firmware controller 104.

In one example, the program instructions 406-414 can be part of an installation package that, when installed, can be executed by the firmware controller 104 to implement the components of the computing device 400. In this case, memory 404 may be a portable medium such as a CD, DVD, or flash drive, or a memory maintained by a server from which the installation package can be downloaded and installed. In another example, the program instructions may be part of an application or applications already installed. Here, memory 404 can include integrated memory such as a hard drive, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A system comprising:
a non-volatile memory;
a firmware controller, communicatively coupled to the non-volatile memory to:
retrieve a set of configurable system options from a configuration segment of the non-volatile memory;
store the set of configurable system options in a reserved storage location;
update a set of firmware instructions from a system segment of the non-volatile memory;
retrieve the set of configurable system options from the reserved storage location; and
restore the set of configurable system options utilizing an application programming interface (API) provided by the firmware instructions.

2. The system of claim 1 wherein set of firmware instructions comprise chipset level drivers.

3. The system of claim 1, the receiving the set of configurable system options comprises accessing an API of an installed set of firmware instructions.

4. The system of claim 3, wherein the set of configurable system options correspond to a set of controlling variables for the installed set of firmware instructions.

5. The system of claim 1, wherein the reserved storage location comprises a reserved secure memory location.

6. A method comprising:
retrieving a set of configurable system options from a configuration segment of a non-volatile memory;
storing the set of configurable system options in a reserved storage location wherein the set of configurable system options are encrypted;
updating a set of firmware instructions from a system segment of the non-volatile memory;
retrieving the set of configurable system options from the reserved storage location;
parsing the set of configurable system options; and
restoring the set of configurable system options utilizing an application programming interface provided by the firmware instructions.

7. The method of claim 6 wherein set of firmware instructions comprise chipset level drivers.

8. The method of claim 6, the receiving the set of configurable system options comprises accessing an API of an installed set of firmware instructions.

9. The method of claim 8, wherein the set of configurable system options correspond to a set of controlling variables for the installed set of firmware instructions.

10. The method of claim 8, wherein the reserved storage location comprises a second non-volatile memory.

11. A computing device comprising:
a memory having instructions stored thereon; and
a processor configured to perform, when executing the instructions to:
retrieving a set of configurable system options from a configuration segment of a non-volatile memory;
storing the set of configurable system options in a reserved storage location;
updating a set of firmware instructions to a system segment of the non-volatile memory, wherein the updating overwrites the system segment and a first portion of the configuration segment;
retrieving the set of configurable system options from the reserved storage location; and
restoring the set of configurable system options to a second portion of the configuration segment utilizing an application programming interface provided by the firmware instructions.

12. The computing device of claim 11 wherein set of firmware instructions comprise chipset level drivers.

13. The computing device of claim 11, the receiving the set of configurable system options comprises accessing an API of an installed set of firmware instructions.

14. The computing device of claim 13, wherein the set of configurable system options correspond to a set of controlling variables for the installed set of firmware instructions.

15. The computing device of claim 11, wherein the reserved storage location comprises a reserved secure memory location.
